(19) United States
(12) Patent Application Publication
(10) Pub. No.: US 2013/0334916 A1
(43) Pub. Date: Dec. 19, 2013

(54) DRIVE SYSTEM

(71) Applicant: SICK STEGMANN GmbH, Donaueschingen (DE)

(72) Inventor: Stefan BASLER, Brigachtal (DE)

(73) Assignee: SICK STEGMANN GmbH, Donaueschingen (DE)

(21) Appl. No.: 13/900,232

(22) Filed: May 22, 2013

(30) Foreign Application Priority Data
Jun. 15, 2012 (EP) 12172 278.9

(51) Int. Cl. H02K 57/00

(52) U.S. Cl. CPC H02K 57/00
USPC 310/71

(57) ABSTRACT

The invention relates to a drive system (10) with an electromotor (20) having an encoder-free control unit (30), such that the electromotor (20) has an interface for digital data transmission.

The invention relates to a drive system in accordance with the preamble of patent claim 1.

The prior art has long been acquainted with encoder-free control systems whose object is to operate an electromotor in controlled fashion without the use a high-resolution rotary encoder that indicates the mechanical rotor position. The knowledge of the rotor position is necessary for controlled operation, however, and in encoder-free control systems the rotor position is determined by the measurement of current and/or voltage and an appropriate set of algorithms. Encoder-free control has various advantages as compared to control using a rotary encoder. In particular, encoder-free systems are usually more cost-effective, since they render superfluous the high-resolution rotary encoder, with its associated cabling. They also have greater reliability and are more robust. However, systems with encoder-free control are disadvantageous in that the encoder-free controls do not measure in absolute fashion over one revolution and are often dependent on motor parameters which themselves may be temperature-dependent. In addition, they do not permit a multi-turn enhancement and do not appear to be suited for safety applications.

The goal of the invention is to further develop an encoder-free drive system, specifically in such a way that additional data can be provided in a cost-effective manner.

This goal is achieved by a drive system with the features of patent claim 1.

Advantageous embodiments and elaborations of the invention are specified in the dependent claims.

The drive system according to the invention, having an electromotor with an encoder-free control system, is distinguished by the fact that the electromotor has an interface for digital data transmission. When the rotor position is measured in known drive systems having electromotors with an encoder-free control, only analogue currents and voltages are transmitted between the control system and the electromotor, and the power or voltage supply is provided by the connecting cable. The invention now provides the capability of digital data transmission, by means of which additional data can be supplied in a cost-effective manner. The further task of the sensor-free control is that of a measuring system for rotor position and speed. The drive system, for which the electromotor also has an interface for digital data transmission, can enable other technical capabilities without imposing the costs of an electromotor with a high-resolution rotary encoder.

The interface will preferably take the form of a bidirectional interface. In a preferred embodiment, the interface is designed as a serial interface.

According to a particularly preferred embodiment the interface is designed as an interface for motor-feedback systems. This permits additional data to be made available—as is customary when motor-feedback systems are used, i.e., motors with a high-resolution rotary encoder—without requiring the expense of a motor-feedback system.

According to a particularly preferred embodiment of the invention, the electromotor has a storage unit which is writable and readable via the interface. Stored in the storage unit are, for example, motor parameters or other data useful to the operation of the electromotor.

The electromotor will preferably have an electronic circuit. In particular, this permits the processing of supplementary data, as identified, e.g., by additional sensors.

According to a preferred embodiment, the electromotor has a sensor that measures a physical magnitude—for example, a temperature sensor, a torque sensor, an acceleration sensor, and/or a vibration sensor. In this way, a variety of data can be obtained on the state of the electromotor. The advantage of a temperature sensor, for example, is that data provided by the temperature sensor can be issued to the control system over the interface, and, if so desired, the motor's control system can be adjusted to the given temperature—for example, in the case of temperature changes, by updating the temperature-dependent motor parameters that are in part relevant to the algorithms of the encoder-free control system. A torque sensor, for example, has the advantage of identifying any overload on the motor.

According to a preferred embodiment of the invention the electromotor has a motor shaft on which means are positioned for a rough determination of the absolute position. Here the means will preferably determine the position on the basis of optical, capacitive, inductive, or magnetic principles. A rough determination of the absolute position is understood to be the determination of position over one revolution, made in order to circumvent the limitation imposed by a sensor-free control, where the resolution is restricted only to electrical periods. For example, the means can take the form of a magnet, whose position is determined by a Hall sensor. With the means for a rough determination of the absolute position, an indication of the position of the rotor position relative to the motor poles can be obtained in a simple and cost-effective manner, to thereby derive data on the absolute position. Naturally it is possible for the means allowing a rough determination of the absolute position to also be used for a more precise determination of the absolute position.

The electromotor will preferably have means for determining multi-turn data, in order to permit the resolution of a number of revolutions of the electromotor shaft.

According to an advantageous elaboration of the invention, data recorded by the electronic circuit and/or the sensors for determining physical magnitudes, and/or the means for a rough determination of the absolute position, and/or the means for determining multi-turn data are writable into the storage unit and readable from the storage unit. This allows, e.g., a kind of electronic journal to be kept for the electromotor. In particular, the data stored in the storage unit can be made available to the guidance system of the electronic motor for the purpose of processing.

The invention will next be described in detail on the basis of the figure. Shown is:

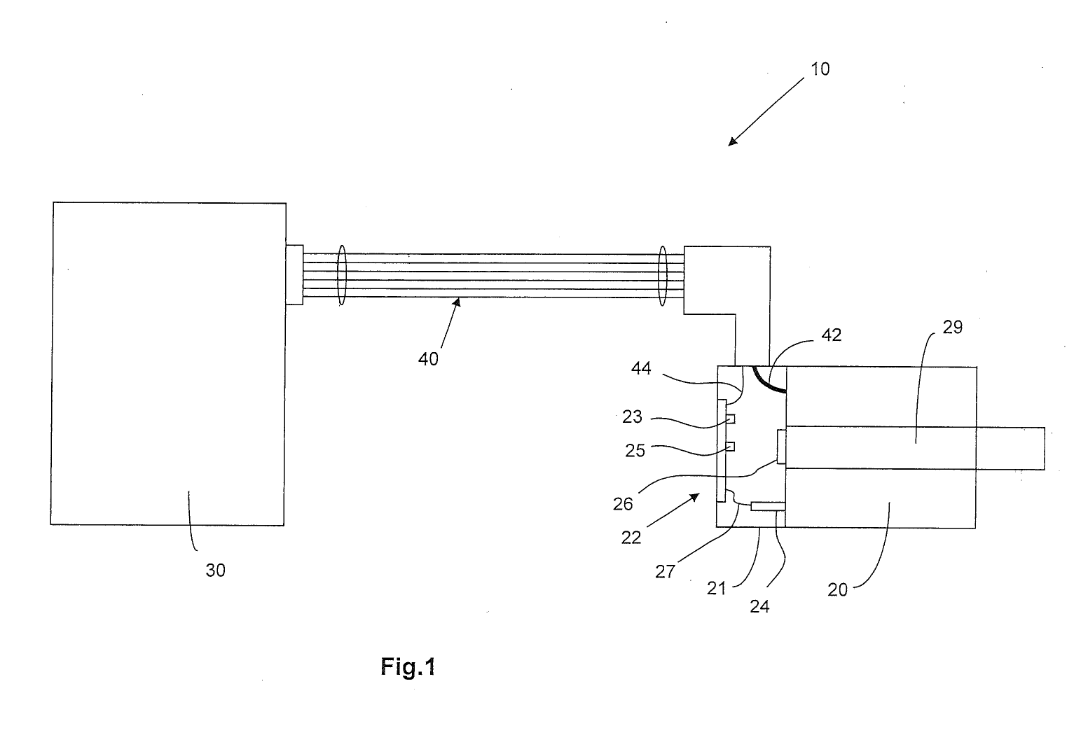

FIG. 1 a schematic depiction of a drive system according to one exemplary embodiment of the invention

The figure schematically depicts a drive system 10 with an electromotor 20 in a housing 21, which is connected to a control element 30 by way of a motor cable 40. The drive system 10 is an encoder-free drive system 10. Thus, it does not have a high-resolution rotary encoder for determining the absolute rotor position of the electromotor 20. Instead, it determines the rotor position by measuring the current and/or voltage and applying appropriate evaluating algorithms.

The motor cable 40 has both a power cable 42, with a plurality of braids for the current and voltage supply of the electromotor, and a data cable 44, which can have, e.g, two braids. The power cable 42 and the data cable 44 can be integrated into one cable harness.

Positioned in the housing 21 of the electromotor 20 is an interface for digital data transmission, by means of which data can be transmitted from the electromotor 20 to the control unit 30. In particular, the interface is realized as a bidirectional, serial interface and preferably as an interface for motor feedback systems. Via the interface, additional data can be transmitted between the electromotor 20 and the control unit 30, specifically, via the data cable 44 of the motor cable 40. Positioned in the housing 21 of the electromotor 20 is, e.g., an electronics module 22, into which the interface can be integrated. In one embodiment the electronics module can have a storage unit 23 which is writable and readable over the interface. Motor parameters, or additional data that are useful in operating the electromotor 20, are retrievably stored in this storage unit 23.

In another embodiment, there can be integrated into the electronics module 22 a temperature sensor 24 which determines the temperature of the electromotor 20 and transmits it to the control unit 30 via the motor cable 40. This allows the encoder-free control of the control unit 30 to be adjusted to the temperature of the electromotor 20 when necessary. To more precisely determine the temperature of the electromotor, an alternative embodiment (shown in FIG. 1) provides that the temperature sensor 24 is positioned directly on the electromotor 20 and is connected to the electronics module 22 over a cable 27.

In another exemplary embodiment, there is positioned within the housing 21—and specifically on a motor shaft 29 of the electromotor 20—a magnet 26 whose position changes upon rotation of the motor shaft as a function of the rotating angle, and whose position can be read out by means of a Hall sensor 25, which is preferably positioned on the electronics module 22. In this way the rotor position relative to the motor poles can be absolutely determined, with a low resolution, but without the need for a high-resolution rotary encoder.

In another embodiment, which is not depicted, a torque sensor, or other sensors for measuring a physical magnitude, can be positioned in the housing 21 of the electromotor 20. The measured data of these sensors can be recorded in the electronics module 22 and, if need be, processed, edited and/or digitized, then stored in the storage unit 23 and transmitted to the control unit 30 over the digital interface.

Through use of the storage unit 23, it is possible, in particular, to conduct a kind of electronic journal for the electromotor 20 if the data recorded by the electronics module 22 and the different sensors (e.g., the temperature sensor 24 or the torque sensor and/or the Hall sensor 25) are stored in the storage unit 23. This data can also be made available to the guidance system of the electromotor 20 for the purpose of processing.

### LIST OF REFERENCE NUMERALS

10 drive system
20 electromotor
21 housing
22 electronics module
23 storage unit
24 temperature sensor
25 Hall sensor
26 magnet
28 cable
29 motor shaft
30 control unit
40 cable
42 power cable
44 data cable

1. Drive system (2) with an electromotor (20) having an encoder-free control system (30),
wherein
the electromotor (20) has an interface for digital data transmission.

2. Drive system according to claim 1,
wherein
the interface is designed as a bidirectional interface.

3. Drive system according to claim 1,
wherein
the interface is designed as a serial interface.

4. Drive system according to claim 1,
wherein
the interface is designed as an interface for motor feedback systems.

5. Drive system according to claim 1,
wherein
the electromotor (20) has a storage unit (23), which is writable and readable by means of the interface.

6. Drive system according to claim 1,
wherein
the electromotor (20) has an electronic circuit (22).

7. Drive system according to claim 1,
wherein
the electromotor (20) has a sensor for determining a physical magnitude, for example, a temperature sensor (24), a torque sensor, an acceleration sensor, and/or a vibration sensor.

8. Drive system according to claim 1,
wherein
the electromotor (20) has a motor shaft (29) on which means are positioned for making a rough determination of the absolute position, and said means will preferably determine the position according to optical, capacitive, inductive, or magnetic principles.

9. Drive system according to claim 1,
wherein
the electromotor (20) has means for determining multiturn data.

10. Drive system according claim 1,
wherein
the data established by the electronic circuit (22) and/or the sensor and/or the means for roughly determining the absolute position and/or the means for determining multiturn data are writable into the storage unit (23) and readable from the storage unit (23).
